(19) United States
(12) Patent Application Publication
(10) Pub. No.: US 2005/0108242 A1
(43) Pub. Date: May 19, 2005

(54) Fingerprint database maintenance method and system

(76) Inventors: Antonius Adrianus Cornelis Maria Kalker, Eindhoven (NL); Jaap Andre Haitsma, Eindhoven (NL)

Correspondence Address: Philips Electronics North America Corporation;Corporate Patent Counsel, PO Box 3001, Briarcliff Manor, NY, 10510, US

(21) Appl. No.: 10/496,544

(22) PCT Filed: Oct. 31, 2002
(86) PCT No.: PCT/IB02/04605

(30) Foreign Application Priority Data
Nov. 29, 2001 (EP) 01204599.3

(51) Int. Cl. G06F 17/30

(52) U.S. Cl. 707/10

(57) ABSTRACT

A method of maintaining a database comprising a fingerprint of and an associated set of metadata for each of a number of multimedia objects. Respective portions (201, 202, 203, 204, 205) of the database are distributed over respective file sharing clients (101-105) connected to a file sharing network (100) arranged for sharing said number of multimedia objects. File sharing clients (101-105) can maintain their own respective portions (201-205) of the database, or transmit fingerprints and metadata to another file sharing client. In the latter case, the other file sharing client is preferably a supermode in the file sharing network (100).

The invention relates to a method of maintaining a database comprising a fingerprint of and an associated set of metadata for each of a number of multimedia objects. The invention further relates to a file sharing client, a computer program product and a file sharing network.

Fingerprints of human beings are already used for over a hundred years to identify people. Conceptually a fingerprint can be seen as a short summary, which is unique for every single human being. Recently a growing interest is seen in the field of multimedia processing to compute fingerprints of multimedia objects. In order to qualify two multimedia objects as the same, instead of comparing the multimedia objects itself, only their fingerprints are compared. A fingerprint of a multimedia object is a representation of the most relevant perceptual features of the object in question. Such fingerprints are sometimes also known as “(robust) hashes”.

In most systems using fingerprinting technology, the fingerprints of a large number of multimedia objects along with their associated respective metadata are stored in a database. The term “metadata” refers to information such as the title, artist, genre and so on for a multimedia object. The metadata of a multimedia object is retrieved by computing its fingerprint and performing a lookup or query in the database using the computed fingerprint as a lookup key or query parameter. The lookup then returns the metadata associated with the fingerprint.

There are several advantages in storing fingerprints for multimedia objects in a database instead of the multimedia content itself. To name a few:
1. The memory/storage requirements for the database are reduced.
2. The comparison of fingerprints is more efficient than the comparison of the multimedia objects themselves, as fingerprints are substantially shorter than the objects.
3. Searching in a database for a matching fingerprint is more efficient than searching for a complete multimedia object, since it involves matching shorter items.
4. Searching for a matching fingerprint is more likely to be successful, as small changes to a multimedia object (such as encoding in a different format or changing the bit rate) does not affect the fingerprint.

An example of a method of generating a fingerprint for a multimedia object is described in International patent application WO 02/065782 (attorney docket PHNL010110), as well as in Jaap Haitsma, Ton Kalker and Job Oostveen, “Robust Audio Hashing For Content Identification”, International Workshop on Content-Based Multimedia Indexing, Brescia, September 2001.

In large-scale systems, the fingerprint database has to be distributed over a considerable number of fingerprint servers to be able to handle all the search requests and to store all the fingerprints. Furthermore, the database has to be kept up to date. For example, in the case of audio fingerprinting, the fingerprints of newly released songs have to be added. Both the necessary servers and keeping the database up-to-date make the system very costly.

It is an object of the invention to provide a method according to the preamble, which is cheaper than the known method.

This object is achieved according to the invention in a method comprising distributing respective portions of the database over respective file sharing clients connected to a file sharing network arranged for sharing said number of multimedia objects.

Using this method, it is no longer necessary to actively go out and buy content e.g. on CD, or to find out the metadata for content yourself. By exploiting the objects and the metadata available from the file sharing clients on the network, fingerprints and metadata can be collected in a very cheap and efficient way. These clients already make the objects available for anyone to download, so buying these objects becomes unnecessary. Further, typically the objects are made available together with metadata, so this metadata can be used as well.

Distributing the database over the file sharing network has the additional advantage that no dedicated database servers or management systems are necessary. The file sharing network already contains a potentially large number of interconnected computers, which provide a well-suited basis for maintaining such a database.

Also, the method according to the invention is more scalable than prior art methods. When more users join the file sharing networks, the number of requests for metadata will increase, and so the requirements on the database server(s) must be increased if a satisfactory response time is desired. However, when the database is distributed over the clients in the file sharing network, then more computers will become available on the network when new users join the network. The extra computing power, storage and connectivity provided by these new computers can then be used to maintain a portion of the database. This way, the capabilities of the distributed database scales together with the demand.

It is a further object of the invention to provide a file sharing client comprising a storage for storing one or more multimedia objects, sharing means for sharing a multimedia object in the storage with other file sharing clients on a file sharing network, fingerprinting means for computing a fingerprint and obtaining a set of metadata for the multimedia object shared by the sharing means, and for adding the computed fingerprint and obtained set of metadata to a database distributed over the file sharing clients connected to the file sharing network.

Such a file sharing client is capable of participating in the method of maintaining a database as outlined above. Because the fingerprinting and data collecting means are integrated in the file sharing client, users who install the file sharing client also automatically install the necessary means to help maintain the distributed database. Thus, when they subsequently join the file sharing network, their computing power, connectivity and storage becomes available to the network, and extends the capabilities of the distributed database.

In an embodiment the file sharing client further comprises DBMS means for maintaining a portion of the distributed database. By installing such database management system means in the file sharing client, anyone who installs the client (usually on a computer system) also installs the DBMS means and so can contribute to the maintenance of the distributed database.

In a further embodiment the size of the portion of the distributed database maintained by the DBMS means is made dependent on the performance of a computer system on which the client is running. For example, bandwidth restrictions, CPU speed and/or available working memory (RAM) could be taken into account. This way, a slow computer would not be burdened with a large fingerprint database server.

In a further embodiment the DBMS means are arranged for adding the computed fingerprint and obtained set of metadata to the respective portion. This way, the distributed database is updated with new fingerprints and sets of metadata from multimedia objects that are present on the file sharing client. Each client now maintains a portion of the distributed database containing at least objects present in its own storage.

In a further embodiment the fingerprinting means are arranged for transmitting the computed fingerprint and the obtained set of metadata to another file sharing client on the file sharing network. This way, data to be stored in the database can be distributed via the file sharing network so that it can be stored in a portion managed by an arbitrary client arranged for managing that portion.

In a variant of the above embodiment the other file sharing client is a super node in the file sharing network. Super nodes are clients which have sufficient bandwidth, processing power and memory. A normal client connects to the network by connecting to a super node and sends the list of the files to be shared to the super node. A super node has connections to a number of clients and furthermore is also connected to a number of other super nodes. Because of their larger capacities in terms of memory, processing power and bandwidth, they are better suited to manage a portion of the distributed database.

In a further embodiment the transmitting is done simultaneously with transmitting a multimedia object to the other file sharing client. These fingerprints are relatively small (in the order of ten kilobytes, as opposed to several megabytes for a typical multimedia object) and so will not affect the performance of the client. This provides a way to distribute the database with fingerprints and metadata in an arbitrary fashion over the clients on the network.

In a further embodiment the fingerprinting means are arranged for computing the fingerprint and obtaining the set of metadata for the multimedia object when the multimedia object is being stored in the storage. By computing the fingerprint at this time, it is achieved that metadata for any newly obtained multimedia object is automatically added to the distributed database.

It is a further object of the invention to provide a computer program product arranged for causing a general purpose computer to function as the file sharing client according to the invention.

It is a further object of the invention to provide a file sharing network comprising at least one file sharing client according to the invention.

These and other aspects of the invention will be apparent from and elucidated with reference to the embodiments shown in the drawing, in which:

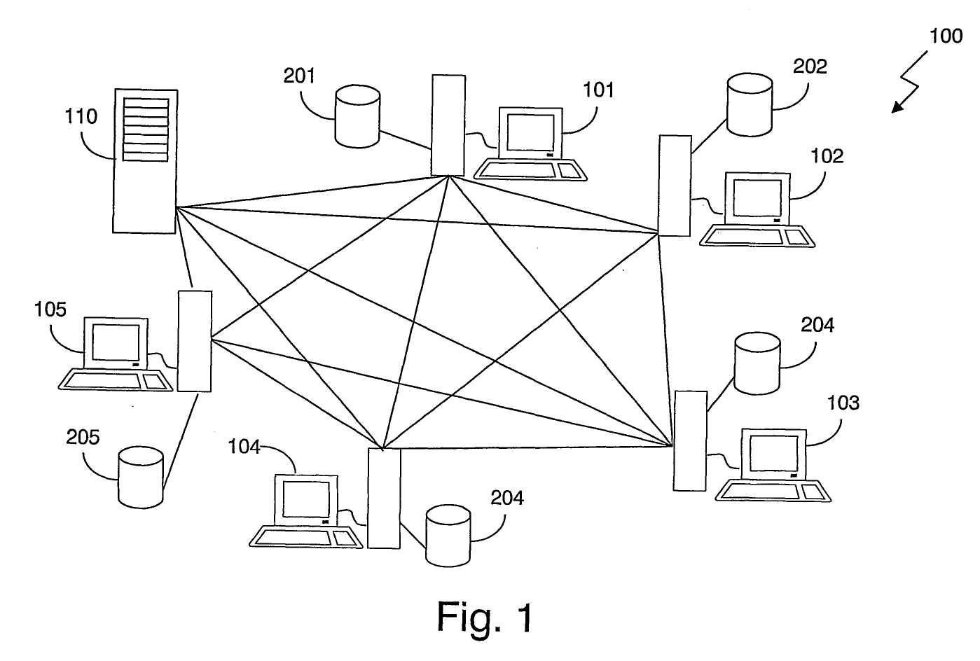

FIG. 1 schematically shows a file sharing network comprising plural clients; and

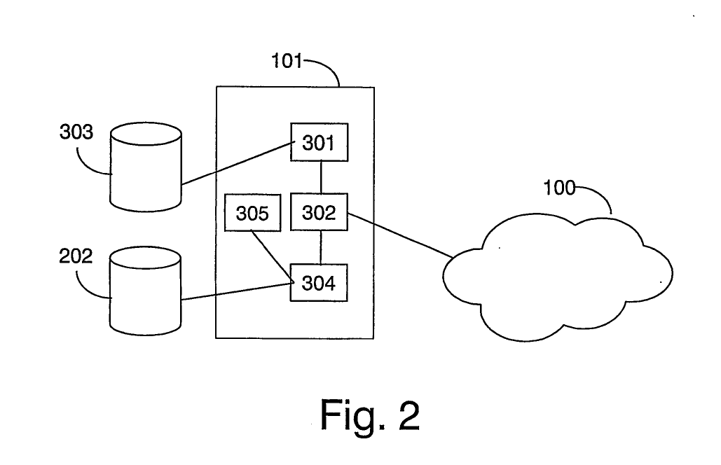

FIG. 2 schematically shows a file sharing client in more detail.

Throughout the figures, same reference numerals indicate similar or corresponding features. Some of the features indicated in the drawings are typically implemented in software, and as such represent software entities, such as software modules or objects.

FIG. 1 schematically shows a file sharing network 100 comprising plural file sharing clients 101, 102, 103, 104 and 105. Although shown here as a physical network, with direct connections between the clients 101-105, the network 100 is best regarded as a conceptual or virtual network. That is, it is not necessary that all clients 101-105 are physically or network-wise directly connected to each other all the time. All that is needed is that one client “on the network” can obtain files or objects from another client. Also, even when direct client-to-client connections are used, it is not necessary that all clients are connected to all other clients.

The network 100 may comprise a server 110, which performs a directory service for the clients 101-105. To connect to the file sharing network 100, a client 101 submits a list of the files (or objects) it wants to share to the server 110. The server 110 combines the lists it receives from all the clients connected to the network 100. Other clients 102-105 can then connect to the server 110 and browse the combined list or search for specific objects on the list. They can subsequently contact the client that has the object they are looking for, and obtain (download) it from that client directly. This way, the server 110 does not directly participate in the sharing of files or objects between the clients 101-105. This approach is well known in the worldwide Napster file sharing network.

It is also possible to realize the network 100 without the server 110. In that case, a client 101 connects to the network 100 by connecting to one or more other clients 102-105 that are already on the network 100. A client searches the network by sending a search request to the clients it is connected to. These clients examine their list of objects which they share, and return a result if the requested object is in that list. Furthermore, the request is forwarded to other clients connected to these clients. This way, the request is distributed throughout the entire network 100 until it is received by a client which can fulfill it, or until all clients have received it and none are able to fulfill it.

Such an embodiment is known from e.g. the Gnutella file sharing network. A disadvantage of this embodiment is that the network 100 is not scalable. Gnutella-like networks currently for example cannot support 1 million clients. Furthermore the network becomes slow if there are a number of “slow” computers, i.e. computers with limited bandwidth to the network 100, processing power and/or memory.

Alternatively the client 101 can, after connecting to the one or more other clients 102-105, submit its list of files or objects it wants to share to those other clients 102-105. The list is then passed on to all the clients on the network 100. This way, all clients know which clients have which files or objects available, and can contact that client directly.

The known KaZaa file sharing network also operates without a server 110, but to overcome the above-mentioned problem uses two types of clients: a super node and a “normal” client. Super nodes are clients which have sufficient bandwidth, processing power and memory. A normal client connects to the network by connecting to a super node and sends the list of the files to be shared to the super node. A super node has connections to a number of clients and furthermore is also connected to a number of other super nodes.

A super node is at the same time also a normal client. That is, for the user the fact that his computer is a super node is transparent. When a user wants to search for a file, his client sends a request to the super node(s) to which his client is currently connected. The super nodes returns the matching files, that are in the lists send by its clients. Furthermore the super node forwards the request, if necessary, to all the super nodes to which it is connected in a fashion similar to the one described above in the Gnutella embodiment. However, since the connections between super nodes have a large bandwidth this approach is much faster than the Gnutella networks. Furthermore it can be scaled up to millions of clients.

Such file sharing networks, typically referred to as peer-to-peer or P2P file sharing networks, have an enormous popularity. Well known examples of these networks are: Napster, Musiccity, Gnutella, Kazaa, Imesh and Bearshare. Once users have installed the appropriate client software on their personal computers, they can share their files and they are able to download files shared by other users. The clients 101-105 may be connected to a network such as the Internet, which facilitates the establishment of the file sharing network 100. A client could e.g. use a direct TCP/IP connection to another client to obtain a file or object.

On the most popular networks, usually over 500,000 people are connected simultaneously. At the time of writing, people are mostly sharing music files (often in the MP3 format), but the sharing of movies is gaining popularity. The term “multimedia object” will be used to denote files containing music, songs, movies, TV programs, pictures and other types of binary data, but also textual data can be shared in this fashion. It is to be noted that a multimedia object may be made up of several different files.

The network 100 also comprises a distributed database. The distributed database is made up of several respective portions 201-205, each of which is maintained by a respective one of the clients 101-105. This will be explained below with reference to FIG. 2.

FIG. 2 shows the file sharing client 101 in more detail. The file sharing client 101 is preferably realized as a personal computer on which file sharing software 301 is running, as is well-known in the art. The file sharing software 301 typically makes use of a networking module 302, such as the TCP/IP stack available in modern operating systems. A storage 303 contains one or more multimedia objects which are shared by the file sharing software 301. Such a storage 303 would typically be a directory on a hard disk. In some cases, the storage 303 may contain a separate portion in which downloaded multimedia objects are stored. This portion, typically also a directory, is not necessarily the same as the directory in which multimedia objects to be shared are stored.

The file sharing client 101 also comprises a fingerprinting module 304, which can compute a fingerprint from a multimedia object. As mentioned above, one method for computing a fingerprint is described in International patent application WO 02/065782 (attorney docket PHNL010110), although of course any method for computing a fingerprint can be used. The fingerprinting module 304 also obtains a set of metadata for the multimedia object. Often this set of metadata is included in or with the multimedia object, so that obtaining the set of metadata is done automatically when obtaining the multimedia object.

The fingerprinting module 304 is preferably realized as one or more hardware or software modules, for example as a plug-in module in the file sharing software 301 running on the client 101.

The fingerprinting module 304 can compute the fingerprints from multimedia objects in the storage 303. The set of metadata for the multimedia object can similarly be obtained by simply reading it from the multimedia object on the storage 303. For instance, a multimedia object with music in the popular MP3 format often contains metadata as an ID3 ‘tag’ at the end of the object.

As computing a fingerprint for multimedia object may be CPU-intensive, care must now be taken to avoid consuming too much CPU power. Doing so might upset the user of the file sharing software as he sees it interfere with his normal use of the system.

The fingerprint can be computed upon user request or alternatively in the background. In the latter case, it is preferred to periodically scan the shared drives or directory for new multimedia objects for which no fingerprint has been computed yet. If any such objects are found, a fingerprint is computed automatically. If no metadata is available for such an object, the user could be prompted to enter a set of metadata.

In any case, once the fingerprinting module 304 has computed a fingerprint for a multimedia object, and has obtained a set of metadata for the multimedia object, it includes fingerprint and set of metadata in the distributed database 201-205. Preferably, the fingerprint and the set of metadata are included in the portion 201 maintained by DBMS module 305.

A fingerprint Database Maintenance (DBMS) module 305 maintains the portion 201 of the distributed fingerprint database. The database 201 contains fingerprints and associated sets of metadata. The database 201 will typically contain for each shared multimedia object a fingerprint and one associated set of metadata, unless of course the storage 303 contains multiple copies of one particular multimedia object.

Additionally, the database 201 could be extended with fingerprints and metadata for multimedia objects downloaded by the file sharing client 101 from other file sharing clients 102-105 on the network 100. A fingerprint for a multimedia object can be computed while that object is being downloaded. Some methods of computing a fingerprint operate on small portions of a multimedia object at a time. For example, the above-mentioned European patent application computes a “sub-fingerprint” for every three seconds of audio data in the multimedia object, and constructs the actual fingerprint from all the sub-fingerprints. Computing the sub-fingerprints can then start once three seconds worth of data has been received.

If the metadata for that object is available as well, the fingerprint and metadata can be included in the database 201 before the object is downloaded completely. If during this process it is determined that the fingerprint is already in the database 201, it is very likely that the user already has a copy of this particular multimedia object in his possession. The user could then be warned, so that he can abort the downloading.

When the file sharing client 101 is downloading a multimedia object from another client 102, the client 101 can also download one or more fingerprints with associated sets of metadata from the client 102. These fingerprints are relatively small (in the order of ten kilobytes, as opposed to several megabytes for a typical multimedia object) and so will not affect the performance of the client 101. This provides a way to distribute the database with fingerprints and metadata in an arbitrary fashion over the clients 101-105 in the network 100.

In the KaZaa file sharing network, the super nodes are preferably used to distribute fingerprints and metadata over the network 100. In a network like the Napster file sharing network, it could be the central server that distributes the fingerprints.

Obtaining the right metadata can also be assisted by super nodes or central servers. A client submits a search request for a particular fingerprint to the super node to which it is connected. The super node passes on the request to the other super nodes. Without a central server that filters the sets of metadata in the database to determine a definite set, the super node would probably receive multiple answers to the query. The super node can then apply majority voting or another technique to determine a definite set of metadata which is then supplied back to the client that submitted the request.

For example, suppose that the sets of metadata received in response to a search request for a particular fingerprint are as follows:
1. (artist=“Jewwel”, title=“Hands”)
2. (artist=“Jewel”, title=“Hands”)
3. (artist=“Jewel”, title=“Hnds”)
4. (artist=“Jewel”, title=“Hands”)
5. (artist=“Jewel”, title=“Hands”)

It can easily be seen that in this example four out of five sets give the name of the artist as “Jewel”, while only one gives the name as “Jewwel”. Using the simple approach that the majority wins, the definite set of metadata would give the name of the artist as “Jewel”. Similarly, four out of five sets give the title of the song as “Hands”, and so the definite set of metadata would also give the title of the song as “Hands”. The same approach can of course be used for other types of metadata included in the sets, such as album title, publication year, genre, URL for the artist's Website and so on.

Other, more advanced techniques for automatically determining a definite value from a plurality of candidate values can of course also be used. Such techniques are common in the field of intelligent agents, where they are used to eliminate noise from information received by an agent. They include decision tree pruning and cross validation. What exactly constitutes a “sufficient number” depends on the technique used.

It is observed that not all sets of metadata are necessarily complete. For example, one set of metadata might contain only the title and the name of the artist for a particular song, while another might also contain the title of the album from which the song was obtained and the year of publication of the album. So the above process should be performed on the individual types of metadata, e.g. once for the title based on all the available titles, once for the artist's name based on all the available artist names, once for the year of publication, and so on. This way, a definite set of metadata is obtained which is as extensive as possible, i.e. which includes not only title and artist but also album title and publication year. Such an extensive definite set of metadata is the most valuable.

The super node could subsequently update its own database with the definite set, so as to avoid having to pass on the query again to all the other super nodes every time one of his clients submits that query again. However, this runs the risk that his information will be outdated at some time.

The size of the portion of the distributed database 201 maintained by DBMS module 305 could be made dependent on the performance of the personal computer on which it is running. For example, bandwidth restrictions, CPU speed and/or available working memory (RAM) could be taken into account. This way, a slow computer would not be burdened with a large fingerprint database server.

The file sharing clients 101-105 can make at least a portion of the database 201-205 available to others. This can be done e.g. by offering a search interface through which clients can submit a fingerprint and receive a set of metadata in return. Various methods of retrieving from a database a set of metadata associated with a submitted fingerprint are known from the above-mentioned International patent application WO 02/065782 (attorney docket PHNL010110), as well as from International patent application WO 02/058246 (attorney docket PHNL010532). Other methods can of course also be used.

If a particular client 101 cannot find a set of metadata associated with the submitted fingerprint in its portion 201 of the distributed database, it could forward the submitted fingerprint to another client 102 to which it is connected in the file sharing network 100. The other client 102 is preferably a super node in the file sharing network 100, if the network 100 comprises super nodes. The other client 102 could similarly forward the submitted fingerprint if it cannot find such a set in its portion 202, and so on until one of the clients 101-105 finds such a set of metadata in its portion 201-205, or until all clients 101-105 in the file sharing network 100 have failed to find such a set.

The contents of the distributed database 201-205 can be made available for free, or only to paying subscribers. Alternatively, a fee could be charged for every query performed on the database. The amount of metadata returned to the client in response to submitting a fingerprint could also be varied: the free service returns only artist and title, and the subscription-based service returns all the metadata available in the database, for example.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of maintaining a database comprising a fingerprint of and an associated set of metadata for each of a number of multimedia objects, the method comprising distributing respective portions of the database over respective file sharing clients connected to a file sharing network arranged for sharing said number of multimedia objects.

2. A file sharing client comprising a storage for storing one or more multimedia objects, sharing means for sharing a multimedia object in the storage with other file sharing clients on a file sharing network, fingerprinting means for computing a fingerprint and obtaining a set of metadata for the multimedia object shared by the sharing means, and for adding the computed fingerprint and obtained set of metadata to a database distributed over the file sharing clients connected to the file sharing network.

3. The file sharing client of claim 2, further comprising DBMS means for maintaining a portion of the distributed database.

4. The file sharing client of claim 3, in which the size of the portion of the distributed database maintained by the DBMS means is made dependent on the performance of a computer system on which it is running.

5. The file sharing client of claim 3, in which the DBMS means are arranged for adding the computed fingerprint and obtained set of metadata to the respective portion.

6. The file sharing client of claim 2, the fingerprinting means being arranged for transmitting the computed fingerprint and the obtained set of metadata to another file sharing client on the file sharing network.

7. The file sharing client of claim 6, in which the other file sharing client is a super node in the file sharing network.

8. The file sharing client of claim 6, in which the transmitting is done simultaneously with transmitting a multimedia object to the other file sharing client.

9. The file sharing client of claim 2, the fingerprinting means being arranged for computing the fingerprint and obtaining the set of metadata for the multimedia object when the multimedia object is being stored in the storage.

10. A computer program product arranged for causing a general purpose computer to function as the file sharing client of claim 2.

11. A file sharing network comprising at least one client as claimed in claim 2.
